(19) United States
(12) Patent Application Publication
(10) Pub. No.: US 2007/0024926 A1
(43) Pub. Date: Feb. 1, 2007

(54) CONTACT IMAGE SENSOR

(76) Inventor: Ho-Min Chung, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/162,043

(22) Filed: Aug. 26, 2005

(30) Foreign Application Priority Data
Aug. 1, 2005 (TW) 094126035

(51) Int. Cl. H04N 1/04

(52) U.S. Cl. 358/482

(57) ABSTRACT

A contact image sensor (CIS) includes a light source module for generating a monochromatic light and transferring the monochromatic light to expose an object; a white light source for generating a white light and transferring the white light to expose the object; and a sensor for sensing the monochromatic light reflected from the object in order to scan the object in a color mode or for detecting the white light reflected from the object in order to scan the object in a BW mode.

### BACKGROUND OF THE INVENTION

1. Field of the Invention

The invention relates to a contact image sensor, and more particularly, to a contact image sensor having a high-speed scanning ability in a BW mode.

2. Description of the Prior Art

A contact image sensor (CIS), a type of linear sensors, is a photoelectric device utilized for scanning a flat pattern or a document into electronic formats in order to provide easy storage, display, or transferring. One characteristic of the contact image sensor is the all-in-one module design. This characteristic not only makes the application products lighter and thinner, but also reduces the manufacturing costs because the contact image sensor is easily fabricated. Recently, the contact image sensor has been mainly utilized in fax machines, scanners, and other similar devices.

Please refer to FIG. 1, which is a diagram of a conventional contact image sensor 100. As shown in FIG. 1, the contact image sensor 100 comprises a strip-shaped light source module 110 (please note that the strip-shaped light source module 110 is also called a linear light source), a rod lens array 120, and a light-sensing device array 130. When the document is being scanned, the strip-shaped light source 110 generates lights to the scan line (this is illustrated as the dotted line on the document 150) of the document 150. Then, the rod lens array 120 focuses the lights reflected from the document 150 and images the lights from the rod lens array 120 on the light-sensing device array 130. Each light-sensing device of the light-sensing device array 130 transforms gray scales or colors of a line into electronic signals. Furthermore, because the roller 1 40 rotates, the document 150 can move with the roller 140. Therefore, the contact image sensor 100 can scan the document 150 line by line into the electronic formats. Please note that the contact image sensor 100 is so-called because the contact image sensor 100 makes direct contact with the document 150.

Please refer to FIG. 2, which is a block diagram of the contact image sensor 100 shown in FIG. 1. As shown in FIG. 2, generally speaking, the strip-shaped light source 110 comprises red, green, and blue light emitting diodes (LEDs) 210, 220, and 230. The red, green, and blue LEDs emit light by utilizing an edge light method such that a low-cost color linear light source. When the image is scanned, the red, green, and blue LEDs 210, 220, and 230 are quickly lit (i.e., activated) in proper sequence to obtain the red, green, and blue signals of the image of the document 150. Furthermore, the rod lens array 120 is composed of a plurality of radial gradient index lens, where the reflectivity of each radial gradient index lens changes along radials such that the radial gradient index lens has a function of imaging. Therefore, the whole rod lens array 120 can image a line of the document in the ratio 1:1 on the sensing device array 130, and the rod lens array 120 is so-called. The light-sensing device array 130 is composed of multiple light-sensing devices in proper length. In earlier years, the contact image sensor 100 often utilized a-Si, CdS, MOS sensor as the above-mentioned light-sensing devices, but in recent years, in order to raise the sensitivity of the light-sensing sensor (in other words, in order to raise the scanning efficiency), the light-sensing device array 130 is often made up of charge coupled device sensors (CCD sensors) manufactured by Si chips or CMOS sensors.

In addition to the above-mentioned strip-shaped light source module 110, rod lens array 120, and light-sensing device array 130, the contact image sensor 100 shown in FIG. 2 further comprises a timing controller 160 and a buffer 170. The timing controller 160 is coupled to the light-sensing array 130 for triggering each light-sensing device of the light-sensing device array 130 at specified time interval. Therefore, luminance (or color) data for each pixel of the document 150 can be continuously outputted as electronic data according to the timings of the timing controller 160. These electronic data become an output signal to drive a next stage circuit (for example, it can be an image signal processing circuit) after being buffered by the buffer 170. Please note, as the operation of the next stage circuit is already well known, further description of the next stage circuit is omitted herein.

As mentioned previously, in the color mode, the red, green, and blue LEDs 210, 220, and 230 of the strip-shaped light source 110 are quickly and sequentially lit (i.e., activated) to obtain the red, green, and blue signals of the image. In addition, the light-sensing device array 130 generates corresponding electronic signals according to the red, green, and blue signals. However, an operational problem occurs because in the black/white mode (i.e., BW mode), the red, green, and blue LEDs 210, 220, and 230 are still utilized as light sources. Generally speaking, for the consideration of scanning efficiency, we can utilize only one of the LEDs as the light source. For example, the red LED 210 can be utilized as a light source in the BW mode. Obviously, the scanning quality is poor if only the red LED 210 is utilized. In this case, when only the red LED 210 is utilized, the red region of the document and the white region of the document are hard to distinguish.

In order to ensure the scanning quality, another method is utilized. That is, all the red, green, and blue LEDs 210, 220, and 230 are still utilized. Until all the red, green, and blue scanning operations have been completely performed, an analysis operation is performed to analyze the red, green, and blue scanning results such that the BW scanning result can be determined. Obviously, this way is not efficient.

### SUMMARY OF THE INVENTION

It is therefore one of the primary objectives of the claimed invention to provide a contact image sensor having good scanning quality and efficiency both in the color and BW modes, to solve the above-mentioned problem.

According to an exemplary embodiment of the claimed invention, a contact image sensor (CIS) is disclosed. The contact image sensor comprises: a light source module, for generating a monochromatic light and transferring the monochromatic light to expose an object; a white light source, for generating a white light and transferring the white light to expose the object; and a sensor, for sensing the monochromatic light reflected from the object to scan the object in a color mode, or for sensing the white light reflected from the object to scan the object in a black/white mode (BW mode).

The contact image sensor can directly utilize a white light source to perform the scanning operation in the BW mode. Because the white light source can directly react to the gray scale of the document in the BW mode, only one scanning operation is needed. In other words, the present invention not only has high scanning quality but also has good scanning efficiency in the BW mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional image sensor.

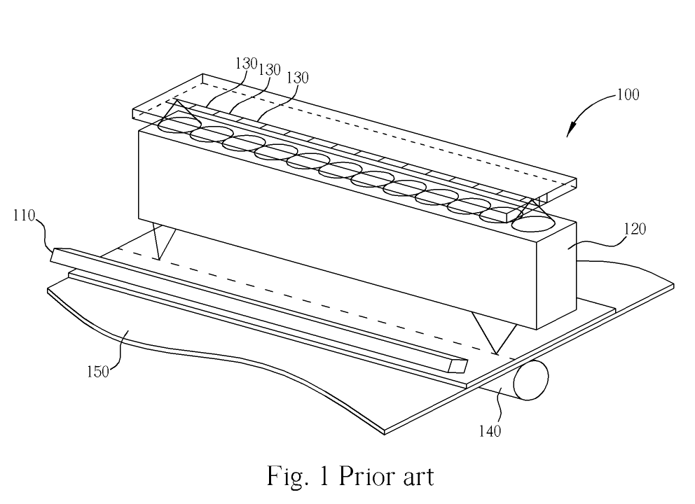

FIG. 2 is a block diagram of the contact image sensor shown in FIG. 1.

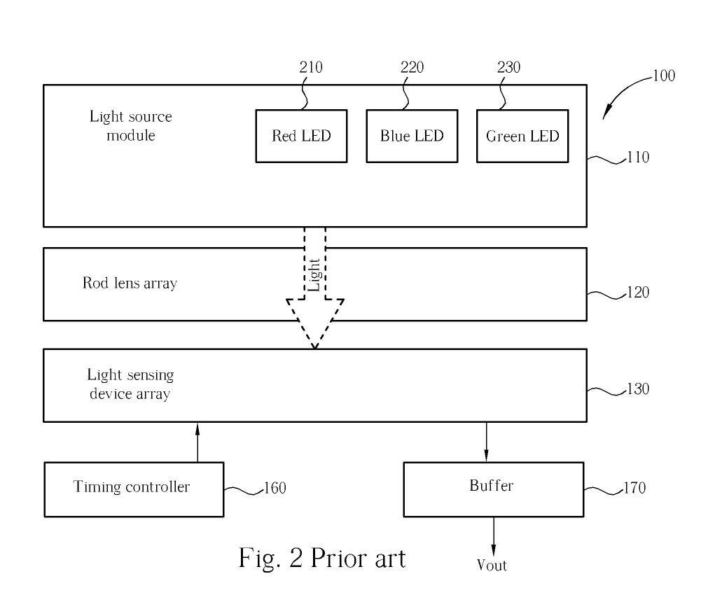

FIG. 3 is a functional block diagram of a contact image sensor according to the present invention.

### DETAILED DESCRIPTION

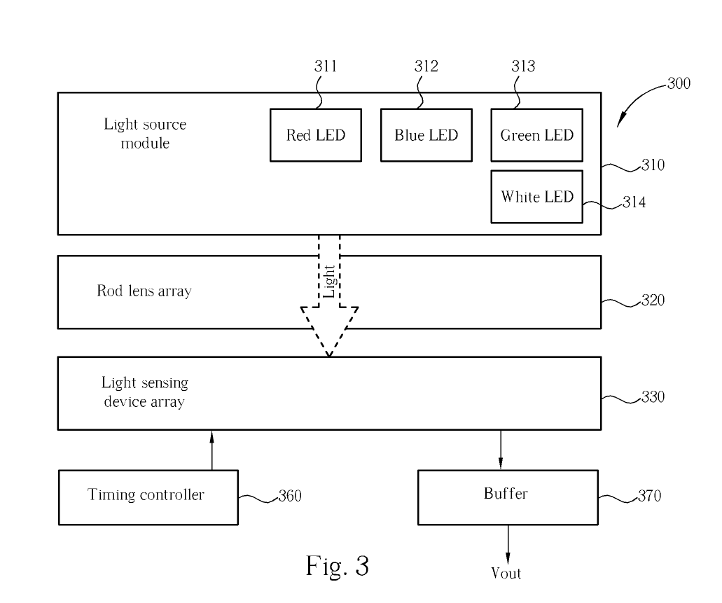

Please refer to FIG. 3, which is a functional block diagram of a contact image sensor 300 according to the present invention. As shown in FIG. 3, the contact image sensor 300 comprises a light source module 310 comprising red, green, blue, and white LEDs 311, 312, 313, and 314; a rod lens array 320; a light-sensing device array 330; a timing controller 360; and a buffer 370. The contact image sensor 300 is similar to the above-mentioned contact image sensor 100. For instance, the light source module 310 is also utilized for generating lights and transferring the lights to expose a document. Then, the rod lens array 320 gathers the lights reflected from the document and images on the light-sensing device array 330. The timing controller 360 is coupled to the light-sensing device array 330. Therefore, each light-sensing device of the light-sensing device array 330 is controlled by the timing controller 360 to transform colors or gray scales of a line of the document into electronic signals. These electronic signals are then buffered by the buffer 370 and outputted as an output signal Vₒᵤₜ in order to drive a next stage of circuit (not shown in FIG. 3). Please note, as mentioned previously, the operation of the next stage circuit is already well known, further description of the next stage circuit is omitted herein.

Please note, the difference between the present invention contact image sensor 300 and the prior art contact image sensor 100 is: the light source module 310 of the present invention contact image sensor 300 comprises not only the red, green, and blue LEDs 311, 312, and 313, but also a white LED 314. In addition, the related operation of the white LED 314 will be illustrated in the following disclosure.

In the color mode, the contact image sensor 300 utilizes the red, green, and blue LEDs 311, 312, and 313 as the light source to obtain the red, green, and blue signals of the image of the document. The light-sensing device array 330 generates corresponding electronic signals according to the red, green, and blue signals. On the other hand, in the BW mode, the contact image sensor 300 utilize the white LED 314 as the light source instead of the above-mentioned red, green, blue LEDs 311, 312, and 313. Because the white LED 314 generates white lights, for the BW mode, the white light can be utilized to quickly determine the gray scales of the document. Therefore, the prior art disadvantage of utilizing only one monochromatic light source can be overcome. For example, utilizing the white light to perform the BW scanning operation can prevent the difficulties in determining the gray scales. Therefore, the scanning quality in the BW mode can be increased. Furthermore, in contrast to the prior art method of utilizing the red, blue, and green LEDs 311, 312, 313 to ensure the scanning quality, the present invention, by only utilizing the white LED, can save the scanning time of utilizing the red, blue, and green LEDs 311, 312, 313. Theoretically, the present invention's scanning efficiency can be three times that of the prior art's scanning efficiency. In other words, the present invention also has a better scanning efficiency.

In addition, the present invention does not limit the light-sensing device of the light-sensing device array 330. In other words, the light-sensing device array 330 can be implemented by CMOS sensors, CCD sensors, or other types of light-sensing devices. This change also obeys the spirit of the present invention.

Obviously, the present invention contact image sensor 300 is utilized to scan a document or any other objects. Therefore, the present invention can be applied to a scanner, a fax machine, a multi-function printer (MFP), a copier, or any other electronic device. In other words, the present invention does not limit the utilization field of the contact image sensor 300. That is, all electronic devices having the scanning function can utilize the present invention contact image sensor 300 to perform BW and color scanning operations.

In contrast to the prior art, the present invention utilizes the red, blue, and green light sources to perform scanning operations in the color mode. Moreover, the present invention directly utilizes the white light source to perform the scanning operation in the BW mode. Because the white light source can directly react to the gray scales of the document in the BW mode, only one scanning operation is needed. Therefore, the present invention not only has high scanning quality, but also has high scanning efficiency in the BW mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A contact image sensor (CIS) comprising:
a light source module, for generating a monochromatic light and transferring the monochromatic light to expose an object;
a white light source, for generating a white light and transferring the white light to expose the object; and
a sensor, for sensing the monochromatic light reflected from the object to scan the object in a color mode, or for sensing the white light reflected from the object to scan the object in a black/white mode (BW mode).

2. The contact image sensor of claim 1, wherein the sensor is a CMOS sensor.

3. The contact image sensor of claim 1, wherein the sensor is a charge coupled device sensor (CCD sensor).

4. The contact image sensor of claim 1, being utilized in a scanner.

5. The contact image sensor of claim 1, being utilized in a copier.

6. The contact image sensor of claim 1, being utilized in a multi-function printer.
